(19) United States
(12) Patent Application Publication
(10) Pub. No.: US 2026/0149134 A1
(43) Pub. Date: May 28, 2026

(54) HYBRID FOIL WELD JOINT AND WELDING METHODS

(71) Applicants: GM Global Technology Operations LLC, Detroit, MI (US); SHANGHAI JIAO TONG UNIVERSITY, Shanghai (CN)

(72) Inventors: Junjie Ma, Novi, MI (US); Changshuai Dou, Shanghai (CN); Hui-ping Wang, Troy, MI (US); Teresa J. Rinker, Royal Oak, MI (US); Masoud MohammadPour, Washington, MI (US); Fenggui Lu, Shanghai (CN); Blair E. Carlson, Ann Arbor, MI (US); Subrahmanyam Goriparti, Troy, MI (US)

(21) Appl. No.: 18/982,741

(22) Filed: Dec. 16, 2024

(30) Foreign Application Priority Data
Nov. 26, 2024 (CN) 202411710295.1

(51) Int. Cl. H01M 50/536

(52) U.S. Cl. CPC H01M 50/536; H01M 2220/20

(57) ABSTRACT

A battery cell, a method of welding electrode foils in a battery, and a method of forming a battery cell. The battery includes a foil stack. The foil stack includes a plurality of foil tabs each extending from a current collector and at least one internal terminal lead. The battery further includes a weld joint formed between the plurality of foil tabs and the at least one terminal lead in the foil stack. A portion of the weld joint includes a weld nugget extending across the plurality of foils into the internal terminal lead, and the remainder of the weld joint includes a diffusion bonding zone extending around at least a portion of the weld nugget.

### INTRODUCTION

Electric and hybrid electric vehicle technology is enabled by the development and deployment of rechargeable, secondary batteries, which provide energy to the vehicle powertrain. Secondary batteries, including lithium ion batteries, often include a number of battery cells. Each battery cell generally includes a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel. Energy density, or areal capacity, of the secondary battery may be increased by adding more cathode and anode active material and increasing the density of the cathode and anode.

In secondary batteries that include prismatic battery cells, the cathode electrode, anode electrode, and separator may be wound into a flattened, jelly roll configuration, or stacked where a ribbon shaped separator is interleaved between layers of the cathode electrode and anode electrode and folded in a manner resembling a z-pattern. In prismatic battery cells, the cathode electrodes and anode electrodes include foil tabs that extend from the jellyroll or stack. The foils for the cathode electrodes are connected together with the cathode internal terminal leads and foils for the anode electrodes are connected together with anode terminal leads. Typically, the foils are connected together with the terminal leads by an ultrasonic process or a laser welding process. In these processes, gaps present between the foils create pores upon welding. Further, due to use of materials that may exhibit relatively high degrees of thermal expansion, such as aluminum, but are fixed in place during the welding process, bulging may occur as the material is heated, further developing and increasing air pockets and pores. In addition, detachment of the foils from the weld joint may occur during welding.

Nonetheless, the present welding processes achieve their intended purpose. However, a need for new and improved welding processes remain offering improved weld joint stability.

### SUMMARY

According to various aspects, the present disclosure is directed to a battery cell. The battery includes a foil stack. The foil stack includes a plurality of foil tabs each extending from a current collector and at least one internal terminal lead. The battery also includes a weld joint formed between the plurality of foil tabs and the at least one terminal lead in the foil stack. A portion of the weld joint includes a weld nugget extending across the plurality of foils into the internal terminal lead, and the remainder of the weld joint includes a diffusion bonding zone extending around at least a portion of the weld nugget.

In embodiments of the above, the weld nugget exhibits a depth in the range of 250 micrometers to 2,200 micrometers relative to an incident surface, and the diffusion bond zone exhibits a depth in the range of 300 micrometers to 2,600 micrometers relative to the incident surface.

In any of the above embodiments, at least one terminal lead includes a first terminal lead and a second terminal lead. The first terminal lead provides a first external surface of the foil stack and the second terminal lead provides a second external surface of the foil stack. Alternatively, the at least one terminal lead is located between two of the plurality of foils and one of the plurality of foils.

In any of the above embodiments, the plurality of foils includes in the range of two to 300 foils.

In any of the above embodiments, the internal terminal leads exhibit a thickness in the range of 0.5 millimeters to 5 millimeters. In further embodiments, the current collector is a cathode current collector and each cathode current collector exhibits a thickness in the range of 5 micrometers to 50 micrometers. In further embodiments, the cathode current collector includes aluminum and the internal terminal lead includes aluminum. Alternatively, the current collector is an anode current collector and each anode current collector exhibits a thickness in the range of 4 micrometers to 50 micrometers. In further embodiments, the anode current collector includes copper and the internal terminal lead includes copper.

In any of the above embodiments, wherein the weld joint includes at least one of an edge joint, an overlap joint, and a lap joint.

According to various additional aspects, the present disclosure relates to a method for welding electrode foils in a battery. The method includes clamping together with at least two clamps a foil stack and applying pressure on the foil stack with the clamps. The foil stack includes a plurality of foil tabs each extending from a current collector and at least one internal terminal lead. A first of the two clamps is positioned on a first external side of the foil stack and a second of the at least two clamps is positioned on a second external side of the foil stack. The method further includes emitting a light beam from a laser onto the second external side of the foil stack. The light beam exhibits a total power of emitted light and emits light in a core and ring pattern. The power in the core is in the range of 30 percent to 70 percent of the total power of emitted light and the power in the ring is in the range of 30 percent to 70 percent of the total power of emitted light. The method yet further includes forming a weld joint. A portion of the weld joint includes a weld nugget formed at least in part by the core of the laser beam and the remainder of the weld joint includes a diffusion bonding zone formed at least in part by the ring of the laser beam.

In embodiments of the above, the method further includes forming the weld nugget to a depth, relative to an incident surface on the second external side of the foil stack, in the range of 250 micrometers to 2,200 micrometers. In further embodiments, the method also includes forming the diffusion bonding zone to a depth, relative to an incident surface on the second external side of the foil stack, in the range of 300 micrometers to 2,200 micrometers.

In any of the above embodiments, the at least two clamps includes a third clamp placed adjacent the second side of the external surface of the foil stack, and the method further includes placing the second clamp to one side of a location of a perimeter of a spot the light beam is incident on the foil stack and placing the third clamp to the other side of the location of the perimeter of the light beam incident on the foil stack.

In any of the above embodiments, the method further includes emitting the light beam at the core at a power in the range of 1,000 W to 2,000 W and emitting the light beam at the ring in the range of 500 W to 1,500 W.

In any of the above embodiments, the ratio of the diameter of the core to the diameter of the ring in the core and ring pattern is in the range of 1:1.5 to 1:4.

In any of the above embodiments, the method further includes the light beam over the second external side at a welding speed in the range of 5 millimeters per second to 150 millimeters per second. In further embodiments, the welding speed is in the range of 40 millimeters per second to 90 millimeters per second.

In any of the above embodiments, the method further includes shaping the light beam, wherein the ring is shaped into a half arc.

In any of the above embodiments, the method further includes oscillating the light beam.

In any of the above embodiments, the method further includes arranging a first of the at least one internal terminal leads at the first external side of the foil stack.

In any of the above embodiments, the method further includes arranging a second of the at least one internal terminal lead at the second external side of the foil stack.

In any of the above embodiments, the method further includes arranging the at least one internal terminal leads between two of the plurality of foils in the foil stack.

In any of the above embodiments, the current collector is a cathode current collector, in the range of 1 to 300 cathode electrodes are present, and the cathode current collectors exhibit a thickness in the range of 5 micrometers to 50 micrometers. Alternatively, in any of the above embodiments, the current collector is an anode current collector, in the range of 1 to 300 anode current collectors are present, and the anode current collectors exhibit a thickness in the range of 4 micrometers to 50 micrometers.

In any of the above embodiments, the plurality of foils are aluminum and exhibit a thickness in the range of 5 micrometers to 50 micrometers and the at least one internal terminal lead is aluminum and exhibits a thickness in the range of 0.5 millimeters to 5 millimeters.

According to various additional aspects, the present disclosure relates to a method of forming a battery cell for a vehicle. The method includes arranging at least one cathode electrode including a cathode current collector, at least one anode electrode, and at least one separator into at least one of a stacked configuration and a jelly roll configuration. The method further includes clamping together with at least two clamps a foil stack and applying pressure on the foil stack with the clamps. The foil stack includes a foil extending from the cathode current collector and at least one internal terminal lead. A first of the two clamps is positioned on a first external side of the foil stack and a second of the at least two clamps is positioned on a second external side of the foil stack. The method further includes emitting a light beam from a laser onto the second external side of the foil stack. The light beam exhibits a total power of emitted light and emits light in a core and ring pattern. The power in the core is in the range of 30 percent to 70 percent of the total power of emitted light and the power in the ring is in the range of 30 percent to 70 percent of the total power of emitted light. The method also includes forming a weld joint. A portion of the weld joint includes a weld nugget formed at least in part by the core of the laser beam and the remainder of the weld joint includes a diffusion bonding zone formed at least in part by the ring of the laser beam. The method yet also includes placing the arranged at least one cathode electrode including a cathode current collector, at least one anode electrode, and at least one separator into a prismatic casing, connecting the internal terminal leads to external terminal leads, sealing the battery casing, and adding electrolyte to the battery casing.

In embodiments of the above, the method further includes forming the weld nugget to a depth, relative to an incident surface on the second external side of the foil stack, in the range of 250 micrometers to 2,200 micrometers and forming the diffusion bonding zone to a depth, relative to an incident surface on the second external side of the foil stack, in the range of 300 micrometers to 2,200 micrometers.

In any of the above embodiments, the method includes emitting the light beam at the core at a power in the range of 1,000 W to 2,000 W and emitting the light beam at the ring in the range of 500 W to 1,500 W, wherein the ratio of the diameter of the core to the diameter of the ring in the core and ring pattern is in the range of 1:1.5 to 1:4, and the welding speed is in the range of 5 millimeters per second to 150 millimeters per second.

In any of the above embodiments, the plurality of foils are aluminum and exhibit a thickness in the range of 5 micrometers to 50 micrometers and the at least one internal terminal lead is aluminum and exhibits a thickness in the range of 0.5 millimeters to 5 millimeters.

### BRIEF DESCRIPTION OF THE DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates an exploded view of a battery cell according to embodiments of the present disclosure.

FIG. 3 illustrates cathode electrodes, anode electrodes, and a separator stacked in a z-stack where the separator is interleaved between the cathode electrodes and the anode electrodes according to embodiments of the present disclosure.

FIG. 4 illustrates a cathode electrode, an anode electrode, and two separators wound into a flattened, jelly roll configuration according to embodiments of the present disclosure.

FIG. 5 illustrates a cross-section of a battery cell according to embodiments of the present disclosure.

FIG. 6 illustrates a method of welding a foil stack according to embodiments of the present disclosure.

FIG. 7 illustrates an end weld according to embodiments of the present disclosure.

FIG. 8A illustrates an overlap weld where in the foil stack includes two internal terminal leads according to embodiments of the present disclosure.

FIG. 8B illustrates an overlap weld where in the foil stack includes one internal terminal lead according to embodiments of the present disclosure.

FIG. 9A illustrates a lap weld where in the foil stack includes two internal terminal leads according to embodiments of the present disclosure.

FIG. 9B illustrates a lap weld where in the foil stack includes one internal terminal lead according to embodiments of the present disclosure.

FIG. 10 illustrates the core and ring pattern of a light beam according to embodiments of the present disclosure.

FIG. 11A illustrates a core and ring pattern of a light beam according to embodiments of the present disclosure.

FIG. 11B illustrates a graph of power versus distance from the center of a light beam according to embodiments of the present disclosure.

FIG. 12A illustrates an oscillation pattern of a light beam according to embodiments of the present disclosure.

FIG. 12B illustrates a graph of power versus distance from the center of a light beam according to embodiments of the present disclosure.

FIG. 13 illustrates a method of forming a battery cell according to embodiments of the present disclosure.

FIG. 14 illustrates the weld depth of the weld nugget and the depth of the diffusion bonding zone, illustrated on the primary, y-axis on the left, and pull strength, illustrated on the secondary, y-axis on the right, as a function of percentage of core laser power illustrated on the horizontal, x-axis according to embodiments of the present disclosure.

FIG. 15 illustrates the relationship between the combined fusion weld nugget depth and diffusion bonding depth and the pull test strength according to embodiments of the present disclosure.

FIG. 16A illustrates an image of a joint failure after pull testing, where the weld joint was prepared according to embodiments of the present disclosure.

FIG. 16B illustrates a close up of the dotted line box of FIG. 16A.

FIG. 17 illustrates a close up of the welded foils after a joint failure in pull testing, where the weld joint was prepared according to embodiments of the present disclosure.

FIG. 18 illustrates the resistance across a weld joint prepared according to amendments of the present disclosure, before and after pull testing.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

Reference to “first,” “second,” “third,” “fourth,” etc. in the specification and claims for designating elements are arbitrary and are intended to assist in the understanding of the disclosure. These references are not necessarily consistent between embodiments or between the specification and claims. In that sense, these references are not intended to limit the elements in any way. The elements are distinguishable by their disposition, description, connections, and function.

The present disclosure is generally directed to a hybrid foil welding process that incorporates the formation of a fusion weld nugget with a solid state diffusion bonding zone. The welding process is used to weld electrode foils and internal terminal leads together for use in a prismatic battery cells. The battery cells may then be used in batteries that are placed into electric or hybrid-electric vehicles.

As used herein, the term “vehicle” is not limited to automobiles. While the present technology is described primarily herein in connection with electric and hybrid-electric vehicles and, specifically batteries, the technology is not limited to electric and hybrid-electric vehicles and batteries. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as in additional applications where multiple layers of relatively thin foil must be welded together.

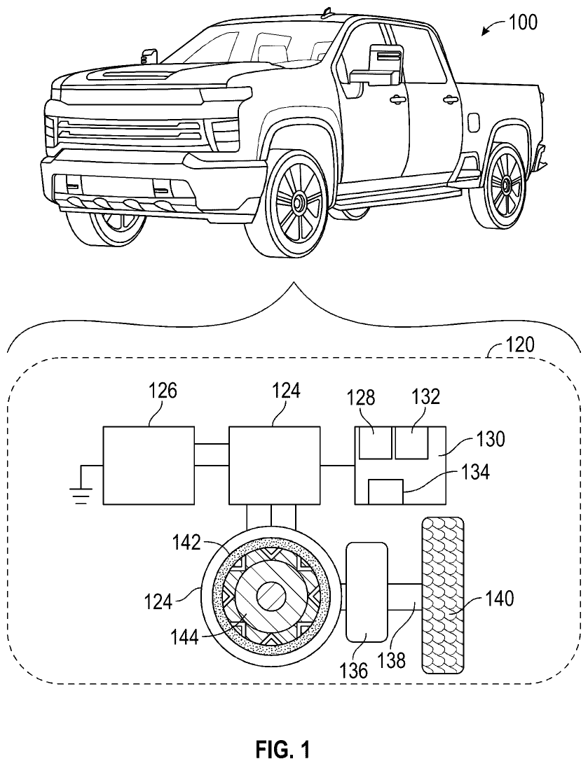

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field of the rotor 144 (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle 100 is in the process of stopping and stores it back in the vehicle battery 126.

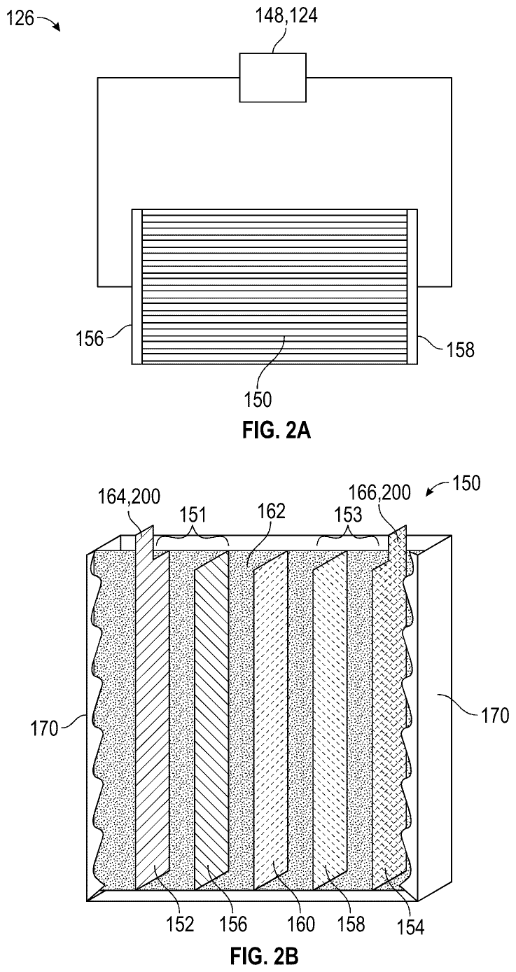

Reference is made to FIGS. 2A and 2B, which illustrate an example of a secondary battery 126 for powering an electric or hybrid electric vehicle 100, such as the electric vehicle 100 illustrated in FIG. 1. As noted above, secondary batteries are understood as rechargeable batteries, that may be discharged upon application of a load and recharged upon the application of an external power source. Referring to FIGS. 2A and 2B, the battery 126 is illustrated as being connected to a load 148, such as the electric motor 124. Other loads 148 include various systems in the vehicle such as climate control systems and infotainment systems. The battery 126 includes one or more battery cells 150, that are assembled together. During discharge, when a load is applied to the battery 126, Li⁺ ions move from the anode 158 to the cathode 156 through the separator 160 by way of the electrolyte 162. Equivalent electrons e-move through the circuitry 146 from the cathode 156 to the anode 158, providing energy to the load 124. While charging, upon application of an external voltage, Li⁺ ions move from the cathode 156 to the anode 158 by way of the electrolyte 162 through the separator 160 and may be intercalated into the anode 158.

Each battery cell 150, such as those illustrated in FIG. 2B, generally include two electrodes. The first electrode is a cathode electrode 151, which includes a cathode current collector 152 and a cathode 156 disposed on the cathode current collector 152. The second electrode is anode electrode 153, which includes an anode current collector 154 and an anode 158 disposed on the anode current collector 154. Each current collector 152, 154 includes a foil tab 164, 166. The foil tabs 164, 166 may be integrally formed with the current collector 152, 154 by trimming or punching each current collector 152, 154 including the foil tab 164, 166 from larger foil sheet. Alternatively, the foil tabs 164, 166 may be welded onto the current collectors 152, 154 after the current collectors 152, 154 have been punched or trimmed. Each battery cell 150 also includes one or more separators 160 positioned between the cathode 156 and anode 158, and an electrolyte 162 such as a liquid electrolyte or a solid state electrolyte that intimately contacts the surface of the separator 160, the cathode 156, and the anode 158.

While the illustrated battery cell 150 of FIG. 2B includes one anode electrode 153 \cathode electrodes 151 and one or more anode electrodes 153. In alternative embodiments, the battery cell 150 may include one or more cathodes electrodes 151 and two or more anode electrodes 153. Further, in embodiments, a cathode 156 may be deposited on one or both sides of the cathode current collector 152 in a given cathode electrode 151 and an anode 158 may be deposited on one or both sides of the anode current collector 154 in a given anode electrode 153.

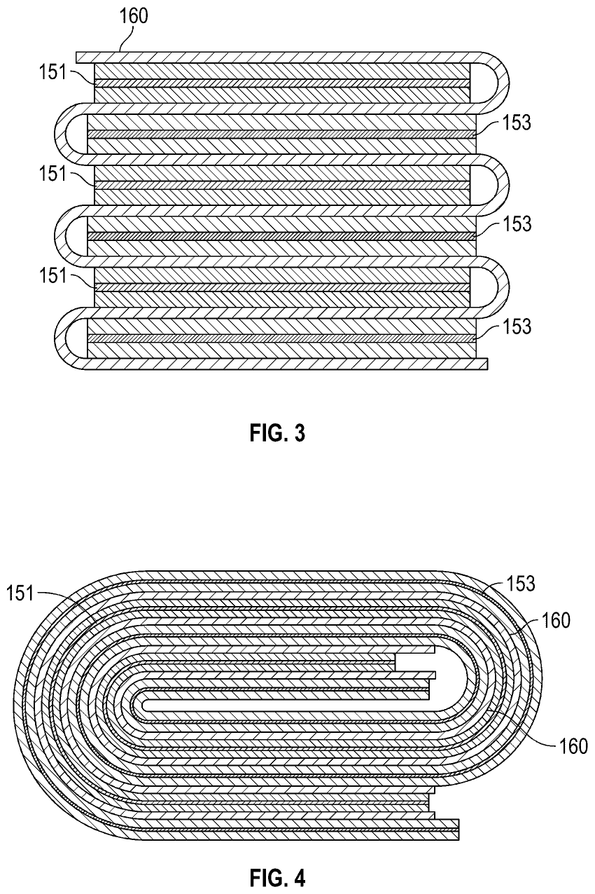

FIG. 3 illustrates an embodiment in which multiple cathode electrodes 151 and anode electrodes 153 are present and a separator is provided between the cathode electrodes 151 and anode electrodes 153. While only three cathode electrodes 151 and three anode electrodes 153 are illustrated, in the range of 1 to 300 cathode electrodes 151 may be present, including all values and ranges therein, such as from 2 to 150 cathode electrodes 151, 30 to 60 cathode electrodes 151, etc., and in the range of 1 to 300 anode electrodes 153 may be present, including all values and ranges therein, such as from such as from 2 to 150 anode electrodes 151, 30 to 60 anode electrodes, etc. Specifically, FIG. 3 illustrates a stacked battery cell 150, where the separator 160 is ribbon shaped and z-folded, or interleaved, between each cathode electrode 151 and anode electrode 153. FIG. 4 illustrates an embodiment where the cathode electrode 151, the anode electrode 153, and separators 160 wound into a jelly roll configuration, which is flattened. Two separators 160 are used to separate the cathode electrode 151 and anode electrode 153. Either configuration, i.e., jellyroll or stacked, may be used in the prismatic style battery cell.

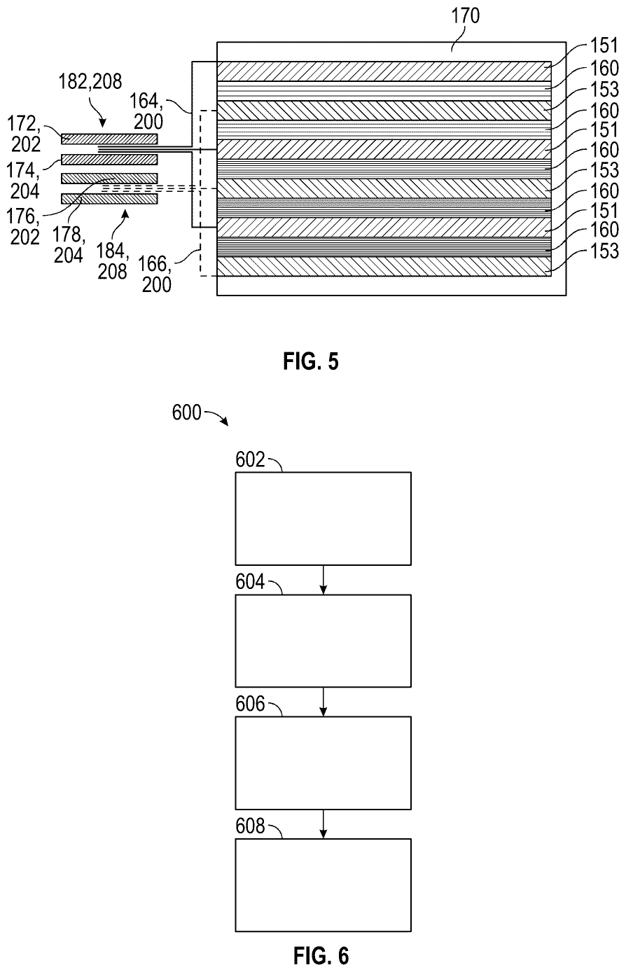

The battery cell 150 includes a casing 170 that is relatively rigid and exhibits a generally cuboid configuration as illustrated in FIG. 2B. With reference to FIG. 5, the foil tabs 164 of the cathode electrodes 151 are welded together to form a cathode foil stack 182 and the foil tabs 166 of the anode electrodes 153 are welded together to form an anode foil stack 184. While one cathode foil stack 182 is shown and one anode foil stack 184 is shown, multiple cathode foil stacks 182 and multiple anode foil stacks 184 may be present. While it is illustrated that the foil tabs 164, 166 protrude from the battery cell 150 in the same direction, in additional or alternative embodiments, the foil stacks 182, 184 may protrude from the battery cell 150 in different directions, such as from opposing directions. In addition, the cathode foil stack 182 includes internal cathode terminal leads 172, 174 and the anode foil stack 184 includes to internal anode terminal leads 176, 178. While two internal terminal leads 172, 174 for the cathode foil tabs 164 and two internal terminal leads 176, 178 for the anode foil tabs 166 are illustrated in FIG. 5, a single internal terminal lead may alternatively be used for each of the foil stacks 182, 184.

The cathode current collector 152 and anode current collector 154 are formed from conductive materials. In embodiments, the cathode current collector 152 includes aluminum. Alternatively, or additionally, the cathode current collector 152 may include copper clad aluminum, and stainless steel. The anode current collector 154 may include one or more of copper, nickel, stainless steel, and titanium. The current collectors 152, 154 are illustrated as being in the form of a foil sheets; however, it should be appreciated that other forms may be exhibited such as mesh sheets. In embodiments, a foil cathode current collector 152 and a foil anode current collector 154 are impermeable to gas. The cathode current collector 152 and the foil tab 164 extending therefrom exhibits a thickness in the range of 5 micrometers to 50 micrometers, including all values and ranges therein, such as in the range of 5 micrometers to 25 micrometers. The anode current collector 154 and the foil tab 166 extending therefrom exhibits a thickness in the range of 4 micrometers to 50 micrometers, including all values and ranges therein, such as in the range of 4 micrometers to 25 micrometers, or 13 micrometers.

In embodiments, the internal terminal leads 172, 174, 176, 178 included in the foil stacks 182, 184 include aluminum. Alternatively or additionally, the internal terminal leads 172, 174, 176, 178 include at least one or more of copper, copper clad aluminum, stainless steel, nickel, and titanium. In particular embodiments, the internal terminal leads 172, 174, 176, 178 include aluminum. The internal terminal leads 172, 174, 176, 178 exhibit a thickness in the range of 0.5 millimeters in thickness to 5 millimeters, including all values and increments therein.

The cathode 156 includes an active material that provides a source of lithium ions (Li⁺ ) and can undergo reversible insertion or intercalation of lithium ions, determining e.g., the capacity and average voltage of a battery. In embodiments, the active material includes at least one of lithium iron phosphate (LFP), lithium cobalt oxide (LiCoO₂), lithium manganese oxide (LiMn₂O₄), lithium manganese iron phosphate (LMFP), and lithium nickel manganese cobalt oxide (LiNiMnCoO₂). The cathode 156 exhibits a thickness in the range of 80 micrometers to 500 micrometers, including all values and ranges therein, such as 110 micrometers. The cathode electrode 151, including both the cathode current collector 152 and the cathode 156, when coated on one side of the cathode current collector 152, exhibits a thickness in the range of 85 micrometers to 550 micrometers including all values and ranges therein and when coated on both sides exhibits a thickness in the range of 165 micrometers to 1050 micrometers including all values and ranges therein for a double sided cathode electrode 151, such as in the range of 205 micrometers to 500 micrometers.

The anode 158 includes materials that can undergo reversible insertion or intercalation of lithium ions at a lower electrochemical potential than the cathode 156 material, such that an electrochemical potential difference exists between the anode 158 and cathode 156. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 158 exhibits a thickness in the range of 50 micrometers to 150 micrometers, including all values and ranges therein. When coated on the anode current collector 154, the anode electrode 153 exhibits a thickness in the range of 54 micrometers to 200 micrometers including all values and ranges therein. When the anode 158 is coated on both sides of the anode current collector 154, the anode electrode 153 exhibits a thickness in the range of 58 micrometers to 250 micrometers including all values and ranges therein.

The separator 160 is a porous material, electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator 160 includes at least one of polyethylene, polypropylene, polyamide, polytetrafluoroethylene, polyvinylidene fluoride, and polyvinyl chloride. In addition, the separator 160 may be filled, i.e., include fillers dispersed therein, wherein the filler includes a material such as glass fiber. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions and the electrolyte travel. The medium may be a liquid, gel, or solid, and capable of conducting the lithium ions between the cathode 156 and the anode 158. The electrolyte 162 permeates the pores of the porous separator 160 and wets, or otherwise contacts, the surfaces of the cathode 156 and anode 158 as well as the separator 160. In embodiments, the electrolyte 162 includes one or more lithium salts dissolved in non-aqueous organic solvent. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(FSO₂)₂) (LiSFI), lithium (triethylene glycol dimethy 1 ether)bis(trifluoromethanesulfonyl)imide (Li(G3)(TFSI), and lithium bis(trifluoromethanesulfonyl)azanide (LiTFSA).

The non-aqueous aprotic organic solvent includes or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethane), cyclic ethers (e.g., tetrahydrofuran, 2-methyltetrahydrofuran), 1,3-dioxolane).

Further, the electrolyte 162 may include a number of additives, such as, but not limited to vinyl carbonate, vinyl-ethylene carbonate, propane sulfonate, 1,3,2-dioxathiolane 2,2-dioxide (DTD), LiPF₂O₂, and combinations thereof. Other additives can include diluents which do not coordinate with lithium ions but can reduce viscosity of the electrolyte 162, such as bis(2,2,2-trifluoroethyl) ether (BTFE), and flame retardants, such as triethyl phosphate.

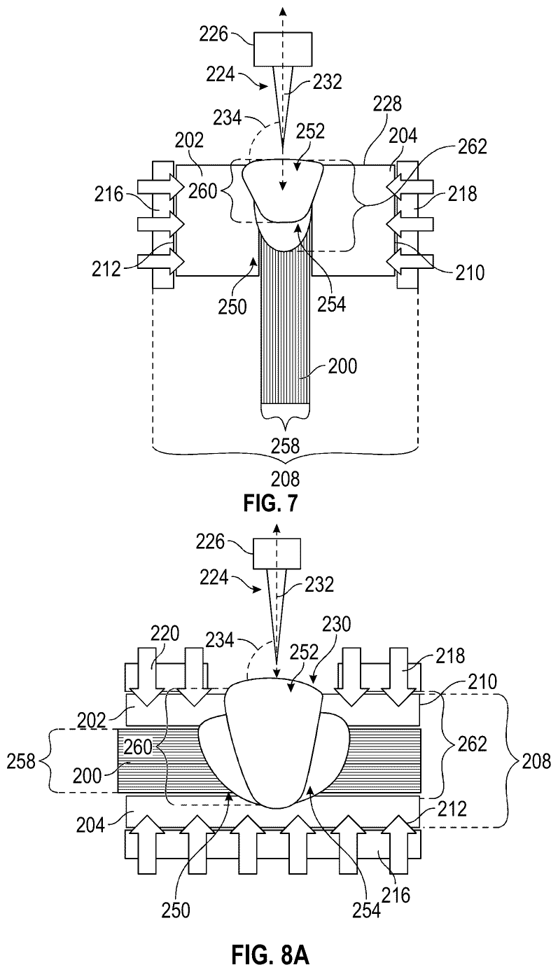

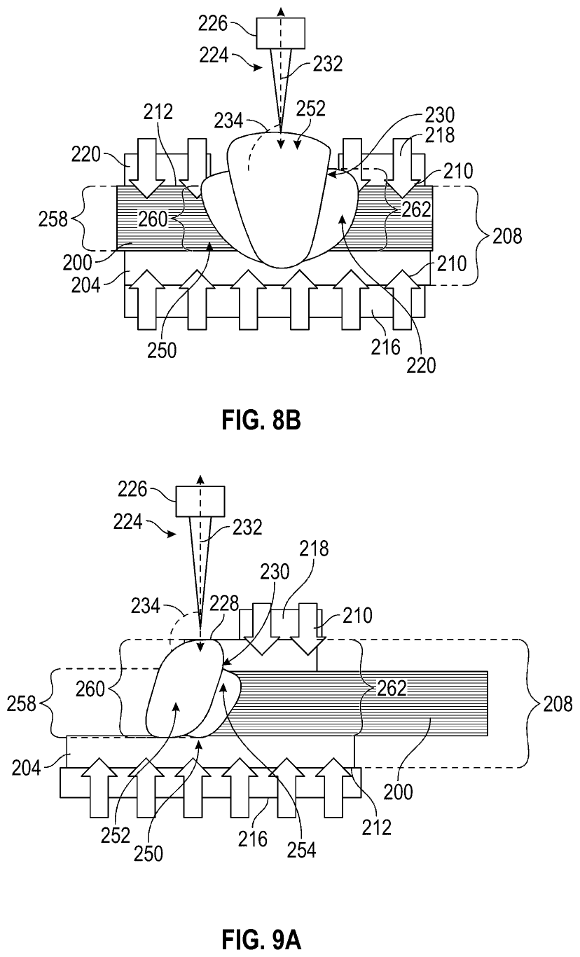

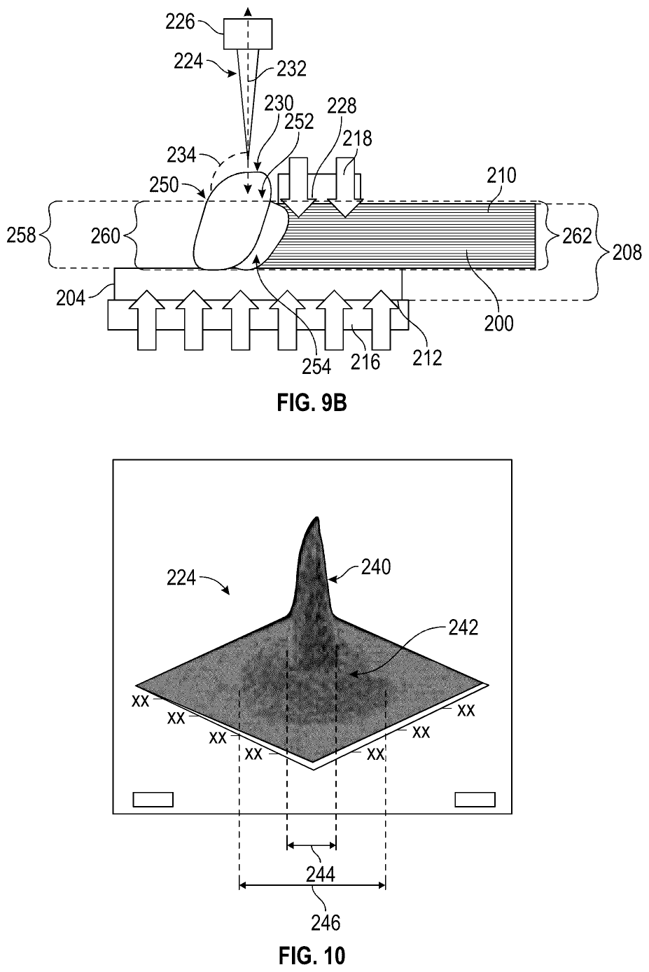

Turning now FIG. 6, a general method 600 of connecting together foil tabs 200, such as foil tabs 164, 166, and the internal terminal leads 202, 204, such as internal terminal leads 172, 174, 176, 178, is illustrated. The method 600 includes at block 602 clamping foil tabs 200, such as from at least one of the cathode current collectors 156 and the anode current collectors 158 described above, together with one or more terminal leads 202, 204 as illustrated in FIGS. 7, 8A, 8B, 9A, and 9B to form a foil stack 208. As illustrated, the weld joints 250 formed may be edge joints, overlap joints, or lap joints. FIGS. 8A and 9A illustrate embodiments where internal terminal leads 202, 204 are clamped adjacent to the foil tabs 200 and provide the external surfaces 210, 212 of the foil stack 208. FIGS. 8B and 9B illustrate embodiments where a single internal terminal lead 204 is included in the foil stack 208. Alternatively, the internal terminal leads 202, 204 may be placed between the foil tabs 200 and the outermost foil tabs 200 provide the external surfaces 210, 212 of the foil stack 208.

The clamps 216, 218, 220 are oriented generally parallel with the alignment of the foil tabs 200 and the internal terminal leads 202, 204 in the foil stack 208. A first clamp 216 is placed adjacent to the first external surface 212, which opposes the second external surface 210. In embodiments, such as illustrated in FIGS. 7, 8A, 8B, 9A, 9B, a second clamp 218 is placed adjacent to the second external surface 210. In further embodiments, where the light beam 224 emitted by the laser 226 intersects a plane formed by the second clamp 218 such as in the case of overlap joints and lap joints, as illustrated in FIGS. 8A, 8B, 9A, and 9B, the second clamp 218 is placed adjacent to the expected location of the perimeter of the light beam 224 spot on the incident surface 228 of the foil stack 208. In additional or alternative embodiments, the at least one clamp 218 is placed adjacent to the expected fusion boundary 230, i.e., the border of the fusion zone where the liquid and solid phases of the metal coexist, and on the solid phase side of the fusion boundary. In yet further embodiments, such as in the case of overlap joints illustrated in FIGS. 8A and 8B, a third clamp 220 is placed on the other side of the expected location of the perimeter of the laser beam 224 spot on the incident surface 228 of the foil stack 208. In FIGS. 9A and 9B where the weld joint 250 is a lap joint, only one clamp 218 may be used on the second external surface 210. The clamps 216, 218, 220 apply pressure against the foil stack 208 and the internal terminal leads 202, 204. The pressure applied by the clamps 216, 218, 220 is in the range of 0 megapascals (MPa) (0 pounds per square inch) to 3.45 megapascals (MPa) (500 pounds per square inch), including all values and ranges therein, such as in the range of 0.1 megapascals to 2.5 megapascals, 1 megapascals to 2 megapascals, etc.

At block 604 a light beam 224 is emitted from a laser 226 onto an incident surface 228 of the foil stack 208, such as the second external surface 212. While the images illustrate the laser axis 232 to be oriented generally orthogonal to the incident surface 228, the laser axis may be oriented at an angle 234 greater than 15 degrees relative to the incident surface 228, including all values and ranges from 15 degrees to 90 degrees.

In addition, the laser 226 generally emits light beam 224 in a core 240 and ring 240 pattern as illustrated in FIG. 10. In embodiments, the power at the core 240 is in the range of 30 percent to 70 percent of the total power being emitted by the laser 226 and the power in the ring 242 is in the range of 30 percent to 70 percent of the total power being emitted by the laser 226. In preferred embodiments, more power is present in the core 240 than in the ring 242. In embodiments, the laser power at the core 240 is in the range of 1,000 W to 2,000 W including all values and ranges therein, depending on the materials used and the material thickness, and the laser power in the ring 242 is in the range of 500 W to 1,500 W, including all values and ranges therein. Too little laser core power yields minimal solid bonding depth and too much laser core power leads to excessive penetration and reduced solid bonding depth, ultimately weaking the weld strength. The ratio of the diameter 244 of the core to the diameter 244 of the ring is in the range of 1:1.5 to 1:4, including all values and ranges therein. Further, in embodiments, the light beam 224 is moved over the second external side 210 and incident surface 228 to provide a welding speed is in the range of 5 millimeters per second to 150 millimeters per second, including all values and ranges therein such as 10 millimeters per second to 90 millimeters per second, 50 millimeters per second, etc. The welding speed is understood herein at the rate at which the laser passes over the workpiece.

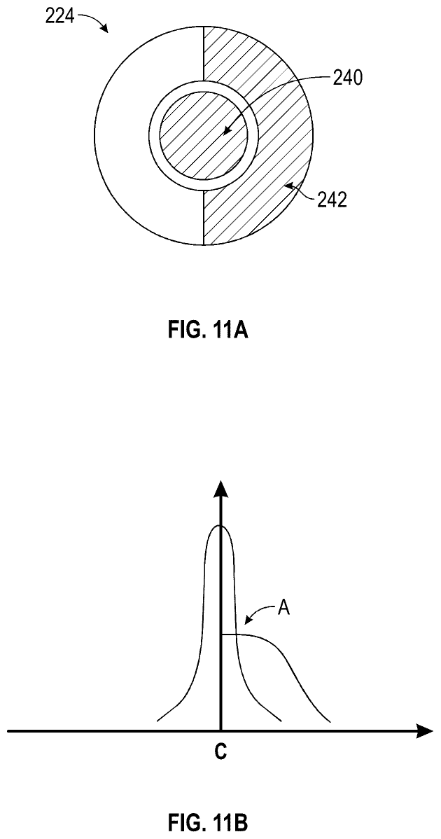

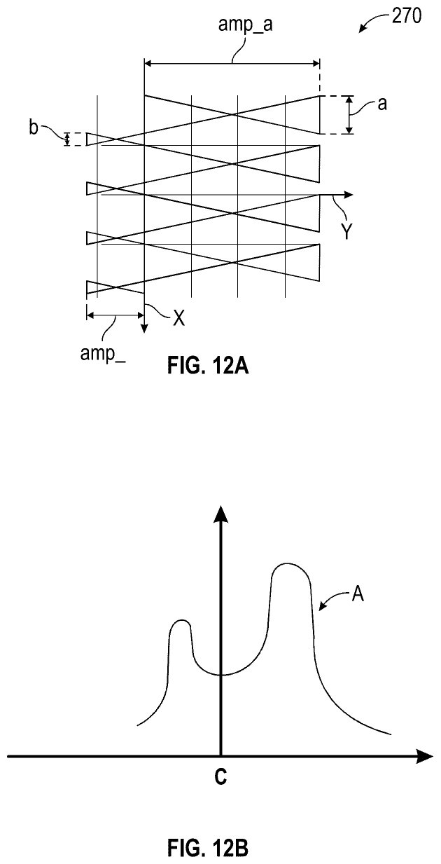

Further, in embodiments, laser energy may be adjusted by shaping the light beam 224 to emit light around half the ring in an arc, on only one side of the core as illustrated in FIGS. 11A and 11B. The arc may extend in the range of 10 percent to 80 percent of the ring 242. FIG. 11B illustrates the power profile A of the light beam 224, wherein power percentage is illustrated in the vertical, y-axis and distance is illustrated in the horizontal x-axis, C being the center of the beam. The laser beam 224 may be shaped using one or more diffractive or reflective elements. Further, in additional or alternative embodiments, the laser 226, and the light beam 224 emitted therefrom, may be oscillated applying an unequal amount of laser energy to enlarge the diffusion bond as illustrated in FIGS. 12A and 12B. Laser oscillations may be facilitated by moving the laser itself or by moving the laser optics relative to the laser and the weld joint 250. FIG. 12A illustrates one embodiment of an oscillation pattern 270. Other oscillation patterns may be used as well. FIG. 12B illustrates the power profile A of the laser oscillation of the oscillation pattern of 12A, wherein power percentage is illustrated in the vertical, y-axis and distance is illustrated in the horizontal x-axis, C being the center of the oscillation pattern. Beam shaping in the manner described above may be used when welding a lap joint, where the foil stack 208 does not extend over both internal terminal leads 202, 204 as illustrated in FIG. 9.

Returning again to FIGS. 6 through 10, at block 606 a weld joint 250 is formed including a weld nugget 252 formed by the core 240 of the laser beam 224 along with a solid-state diffusion bonding zone 254 formed around a portion the weld nugget 252 by the ring 242 of the light beam 224. The weld nugget 250 is a pool of molten metal that is generally formed by the core of the light 224 emitted by the laser 226 that hardens into a nugget shape upon cooling. The weld nugget 252 extends across the plurality of foil tabs 200 and is thicker than the thickness 258 of the foil tabs 200 in the foil stack 208. Further, the weld nugget 252 extends into the adjoining internal terminal leads 202, 204. The depth 260 of the weld nugget 252 relative to the incident surface 228 is in the range of 250 micrometers to 2,200 micrometers, including all values and ranges therein. The diffusion bonding zone 254 is present in the heat affected zone (HAZ). In the diffusion bonding zone 254, the atoms from a first surface migrate into adjoining surfaces due to the pressure provided by the clamps 216, 218, 220 and heat generated by the light beam 224 emitted from the laser 226. Thus, in the diffusion bonding zone 254, the metal does not melt. The diffusion bonding zone 254 extends across the foil tabs 200 around at least a portion of the weld nugget 252. The depth 262 of the diffusion bonding zone 220 relative to the incident surface 204 is in the range of 300 micrometers to 2,600 micrometers, including all values and ranges therein. At block 608, the foil stack 208 connected to the internal terminal leads 202, 204 is removed from the clamps 216, 218, 220. The method 600 may then be repeated for the other foil stack. In addition, the resulting weld joints 250 exhibit a pull strength in the range of 230 Newtons to 600 Newtons, including all values and ranges therein, when 40 foil tabs 200 or more are present.

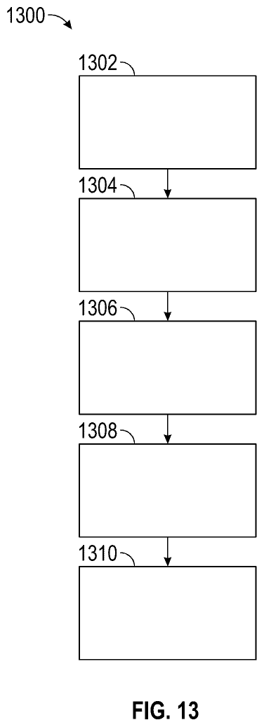

A method of forming a battery cell 150 is illustrated in FIG. 13 and with further reference to FIGS. 7 through 11. The method 1300 includes at block 1302 arranging at least one cathode electrode 151, at least one anode electrode 153, and at least one separator 160 into a stacked or jelly roll configuration. At block 1304 the foil tabs 200 of the cathode electrodes 151 and anode electrodes 153 are welded with the internal terminal leads 202, 204 of the cathode electrodes 151 and anode electrodes 153 according to the method 600 described above with reference to FIG. 6. The jellyroll or stacked cathode electrodes 151, anode electrodes 153, and separators 160 including the welded on internal terminal leads 202, 204 are placed into the casing 170 at block 1306. At block 1308, internal terminal leads 202, 204 are connected to external terminals extending from the battery casing 170. At block 1310, the battery casing 170 is sealed. At block 1320, the electrolyte 162 is added to the casing 170 if it was not already included in the jellyroll or stacked layers as a solid state electrolyte.

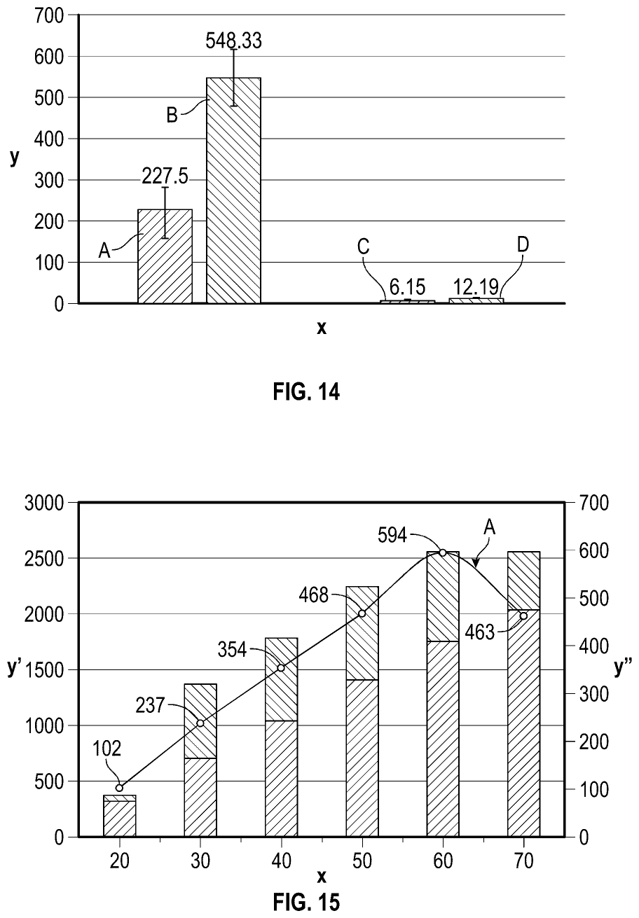

A comparative example was prepared including 40 layers of aluminum foil (simulating the foil tabs 164, 200) having a thickness of 480 micrometers were bonded with 2.5 millimeter aluminum sheet (simulating the internal terminal leads) using a 37 millimeter lap joint. The joint was formed using ultrasonic and laser. A sample was then prepared according to the method herein using 40 layers of aluminum cathode current collectors 152 with foil tabs 164 extending therefrom having a thickness of 480 micrometers were bonded with 2.5 millimeter aluminum sheet using a 45 mm edge weld as illustrated in FIG. 7. The results are illustrated in FIG. 14, wherein the load at break measured in Newtons is illustrated in on the primary vertical, y-axis, the comparative example is bar A and broke at 227.5 Newtons and the example prepared according to the present disclosure is illustrated in bar B and broke at 548.33 Newtons. The strength of the two welds were compared. Newtons per millimeter is illustrated on the secondary, vertical, y-axis. The force at break for the welds were 227.5 Newtons per 37 millimeters (bar C) and 548.22 Newtons per 45 millimeters (bar D); averaging 6.15 Newtons per millimeter and 12.19 Newtons per millimeter, respectively.

Multiple pull strength tests were performed using different core/ring power ratios with a total laser power emitted of 1.7 kW to edge bond 2.5 millimeters aluminum sheets to 12 micrometer aluminum foils. The weld speed was 50 millimeters per second and the core to ring power ratio was adjusted at 10 percent increments between 20 percent core power of the total power emitted by the laser to 70 percent core power of the total power emitted by the laser. The relationship between the combined fusion weld nugget depth and diffusion bonding depth and the pull test strength is shown in FIG. 15. The penetration depth of the weld nugget in micrometers is illustrated on the primary vertical, y′-axis in the lower portion of the graph bars, and the solid state diffusion bond depth also measured in micrometers is illustrated on the primary vertical, y′-axis in the upper portion of the graph bars. The pull strength measured in Newtons is illustrated by the scatter plot line A on the secondary, vertical y″ axis.

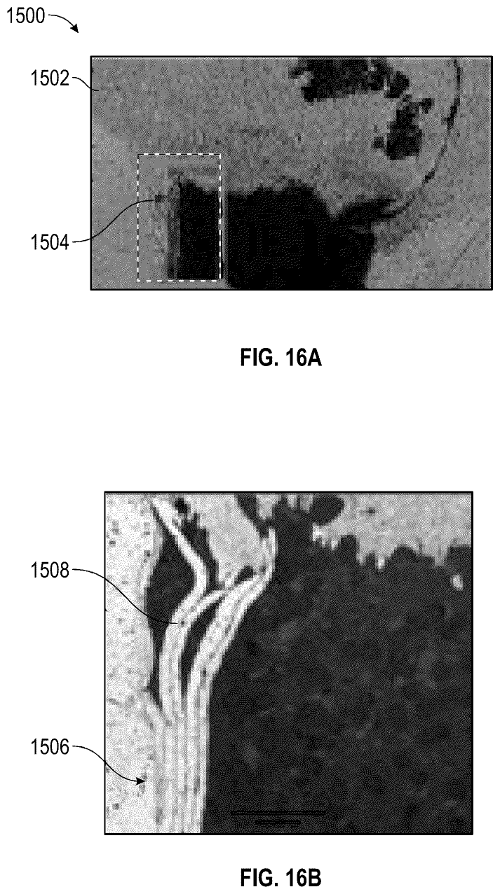

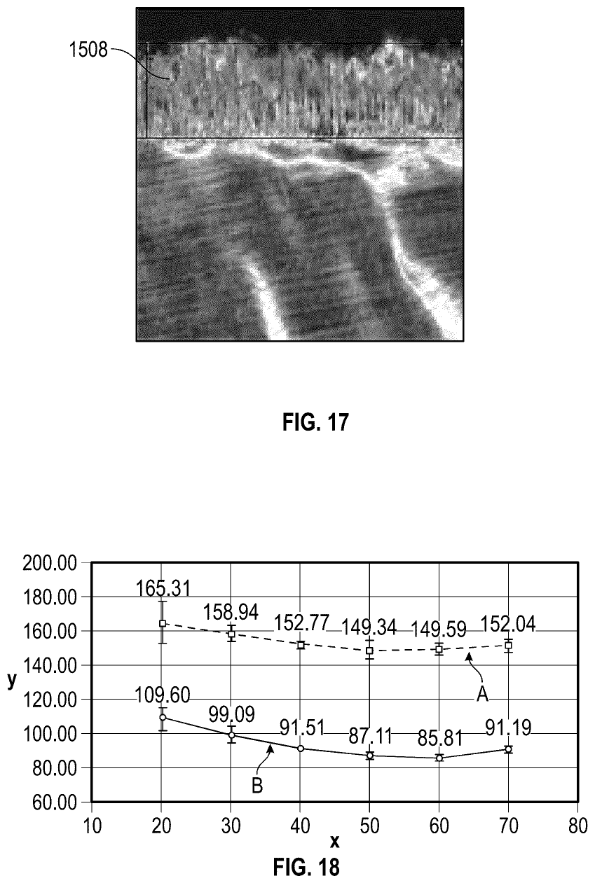

It was found that using 60% of the laser power in the core and 40% of the laser power in the ring yielded the maximum depth of both the weld nugget and diffusion bonding, resulting in the highest weld strength. Utilizing 20% power in the core yields a minimal solid bonding depth in the joint, resulting in the weakest strength. On the other hand, employing 70% power in the core leads to excessive penetration but reduced solid bonding depth, ultimately reducing the weld strength compared to 60 % power. The weld failure in the weld joint 1500 took place at the foil diffusion bond 1502 and weld nugget 1504 as illustrated in FIG. 16A. FIG. 16B demonstrates the successful diffusion bonding of foils to aluminum sheets 1506, as evidenced by the presence of foils 1508 that remained attached to the aluminum sheet after the pull test. Upon examining the foils 1508 that were pulled out from the weld joint, it is evident that they were securely diffusion bonded together as illustrated in FIG. 17.

The resistance before and after the pull test of the sample prepared according to the present disclosure was measured using the four wire method to measure resistance. As illustrated in FIG. 18, in both the before (B) and after (A) pull test samples, the resistance, measured in milliohms and displayed on the vertical, y-axis was found to decrease as the percentage of core power applied reached 70 percent power where resistance began to increase again, core power percentage being illustrated on the horizontal, x-axis. In addition, the resistance after fracture (A) was found to be higher than the resistance before (B) the pull test. This indicates that diffusion bonding improved the electrical conductivity of the weld joints, given the fracture occurred between the weld nugget and the diffusion bonded region of the foils.

The welding process herein and assembled components produced by the process herein offer a number of advantages. These advantages include the improvement in performance of sheet welds including an improvement in weld joint strength. These advantages also include an enhancement in the conductivity of the weld joints. These advantages further include a reduction in porosity and detachments between the foils.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell, comprising:
a foil stack, wherein the foil stack includes a plurality of foil tabs each extending from a current collector and at least one internal terminal lead; and
a weld joint formed between the plurality of foil tabs and the at least one terminal lead in the foil stack, wherein a portion of the weld joint includes a weld nugget extending across the plurality of foil tabs into the internal terminal lead, and the remainder of the weld joint includes a diffusion bonding zone, wherein the diffusion bonding zone extends around at least a portion of the weld nugget.

2. The battery cell of claim 1, wherein the weld nugget exhibits a depth in the range of 250 micrometers to 2,200 micrometers relative to an incident surface, and the diffusion bonding zone exhibits a depth in the range of 300 micrometers to 2,600 micrometers relative to the incident surface.

3. The battery cell of claim 1, wherein at least one terminal lead includes a first terminal lead and a second terminal lead, wherein the first terminal lead is configured to provide a first external surface of the foil stack and the second terminal lead is configured to provide a second external surface of the foil stack.

4. The battery cell of claim 1, wherein the plurality of foil tabs includes in the range of two to 300 foils.

5. The battery cell of claim 1, wherein the internal terminal leads exhibit a thickness in the range of 0.5 millimeters to 5 millimeters.

6. The battery cell of claim 5, wherein the plurality of foil tabs includes in the range of two to 300 foils and the current collector is a cathode current collector and each cathode current collector exhibits a thickness in the range of 5 micrometers to 50 micrometers.

7. The battery cell of claim 6, wherein the cathode current collector includes aluminum and the internal terminal lead includes aluminum.

8. The battery cell of claim 5, the plurality of foil tabs includes in the range of two to 300 foils and the current collector is an anode current collector and each anode current collector exhibits a thickness in the range of 4 micrometers to 50 micrometers.

9. The battery cell of claim 8, wherein the anode current collector includes copper and the internal terminal lead includes copper.

10. The battery cell of claim 1, wherein the weld joint includes at least one of an overlap joint, a lap joint, and an edge joint.

11. A method of welding electrode foils, comprising:
clamping together with at least two clamps a foil stack, wherein the foil stack includes a plurality of foil tabs each extending from a current collector and at least one internal terminal lead, wherein a first of the two clamps is positioned on a first external side of the foil stack and a second of the at least two clamps is positioned on a second external side of the foil stack;
applying pressure on the foil stack with the clamps;
emitting a light beam from a laser onto the second external side of the foil stack, wherein the light beam exhibits a total power of emitted light and emits light in a core and ring pattern, wherein the power in the core is in the range of 30 percent to 70 percent of the total power of emitted light and the power in the ring is in the range of 30 percent to 70 percent of the total power of emitted light; and
forming a weld joint, wherein a portion of the weld joint includes a weld nugget formed at least in part by the core of the laser beam and the remainder of the weld joint includes a diffusion bonding zone formed at least in part by the ring of the laser beam.

12. The method of claim 11, further comprising forming the weld nugget to a depth, relative to an incident surface on the second external side of the foil stack, in the range of 250 micrometers to 2,200 micrometers, and forming the diffusion bonding zone to a depth, relative to an incident surface on the second external side of the foil stack, in the range of 300 micrometers to 2,200 micrometers.

13. The method of claim 11, wherein the at least two clamps includes a third clamp placed adjacent the second side of the external surface of the foil stack, further comprising placing the second clamp to one side of a location of a perimeter of a spot the light beam is incident on the foil stack and placing the third clamp to the other side of the location of the perimeter of the light beam incident on the foil stack.

14. The method of claim 11, further comprising emitting the light beam at the core at a power in the range of 1,000 W to 2,000 W and emitting the light beam at the ring in the range of 500 W to 1,500 W.

15. The method of claim 11, further comprising arranging a first of the at least one internal terminal leads at the first external side of the foil stack and arranging a second of the at least one internal terminal lead at the second external side of the foil stack.

16. The method of claim 11, wherein the current collector is a cathode current collector, in the range of 2 to 300 cathode electrodes are present, and the cathode current collectors exhibit a thickness in the range of 5 micrometers to 50 micrometers.

17. The method of claim 11, wherein the current collector is an anode current collector, in the range of 2 to 300 anode current collectors are present, and the anode current collectors exhibit a thickness in the range of 4 micrometers to 50 micrometers.

18. The method of claim 11, wherein the plurality of foils are aluminum and exhibit a thickness in the range of 5 micrometers to 50 micrometers and the at least one internal terminal lead is aluminum and exhibits a thickness in the range of 0.5 millimeters to 5 millimeters.

19. A method of forming a battery cell for a vehicle, comprising:
arranging at least one cathode electrode including a cathode current collector, at least one anode electrode, and at least one separator into at least one of a stacked configuration and a jelly roll configuration;
clamping together with at least two clamps a foil stack, wherein the foil stack includes at least one internal terminal lead and a foil tab extending from at least one of the cathode current collector and the anode current collector, wherein a first of the two clamps is positioned on a first external side of the foil stack and a second of the at least two clamps is positioned on a second external side of the foil stack;
applying pressure on the foil stack with the clamps;
emitting a light beam from a laser onto the second external side of the foil stack, wherein the light beam exhibits a total power of emitted light and emits light in a core and ring pattern, wherein the power in the core is in the range of 30 percent to 70 percent of the total power of emitted light and the power in the ring is in the range of 30 percent to 70 percent of the total power of emitted light;
forming a weld joint, wherein a portion of the weld joint includes a weld nugget formed at least in part by the core of the laser beam and the remainder of the weld joint includes a diffusion bonding zone formed at least in part by the ring of the laser beam;
placing the arranged at least one cathode electrode including a cathode current collector, at least one anode electrode, and at least one separator into a prismatic casing;
connecting the internal terminal leads to external terminal leads;
sealing the battery casing; and
adding electrolyte to the battery casing.

20. The method of claim 19, further comprising emitting the light beam at the core at a power in the range of 1,000 W to 2,000 W and emitting the light beam at the ring in the range of 500 W to 1,500 W, wherein the ratio of the diameter of the core to the diameter of the ring in the core and ring pattern is in the range of 1:1.5 to 1:4, and the welding speed is in the range of 5 millimeters per second to 150 millimeters per second; and forming the weld nugget to a depth, relative to an incident surface on the second external side of the foil stack, in the range of 250 micrometers to 2,200 micrometers and forming the diffusion bonding zone to a depth, relative to the incident surface on the second external side of the foil stack, in the range of 300 micrometers to 2,200 micrometers.
